(19) United States
(12) Patent Application Publication
(10) Pub. No.: US 2022/0214554 A1
(43) Pub. Date: Jul. 7, 2022

(54) OPTICAL COMBINER

(71) Applicant: NAKAHARA OPTO-ELECTRONICS LABORATORIES, INC., Mito-shi, Ibaraki (JP)

(72) Inventors: Koichi ARISHIMA, Mito-shi, Ibaraki (JP); Motohiro NAKAHARA, Mito-shi, Ibaraki (JP)

(21) Appl. No.: 17/606,983

(22) PCT Filed: Feb. 19, 2020
(86) PCT No.: PCT/JP2020/006506

§ 371 Date: Oct. 27, 2021

(30) Foreign Application Priority Data
May 8, 2019 (JP) 2019-088495

(51) Int. Cl. G02B 27/12; G02B 3/00

(52) U.S. Cl. CPC G02B 27/123; G02B 3/0087

(57) ABSTRACT

An optical combiner using a graded index lens that emits light incident on an incident end surface from an emission end surface, the optical combiner including partial regions having different distances from the emission end surface of the graded index lens, on the incident end surface of the graded index lens, in which wavelengths of lights focused on an optical axis of the emission end surface are determined in advance for the respective partial regions.

### TECHNICAL FIELD

The present disclosure relates to an optical combiner.

### BACKGROUND ART

An optical combiner that couples a plurality of different wavelength lights to one optical fiber has been proposed, and various application examples have been proposed. Examples thereof include medical and biological applications such as confocal microscope and flow cytometry, and display applications such as head-up display, virtual reality (VR) glasses, and retinal scanning glasses (see, for example, Patent Literature 1). In recent years, as a means for realizing virtual reality (VR), augmented reality (AR), mixed reality (MR), and the like, ultra-compact display devices have been actively developed, and it is essential to couple lights having greatly different wavelengths, such as red (R), green (G), and blue (B) to one optical fiber as a light source thereof.

### CITATION LIST

### Patent Literature

Patent Literature 1: JP 2018-510379 A

### SUMMARY OF INVENTION

### Technical Problem

An object of the present disclosure is to provide an optical combiner that couples lights having greatly different wavelengths.

### Solution to Problem

The optical combiner of the present disclosure is

an optical combiner using a graded index lens that emits light incident on an incident end surface from an emission end surface, the optical combiner including;

partial regions each having different distances from the emission end surface of the graded index lens, on the incident end surface of the graded index lens, in which

a wavelength of light focused on an optical axis of the emission end surface is determined in advance for each of the partial regions.

In the optical combiner of the present disclosure, collimated light generation units using graded index lenses that each convert light having a wavelength determined for each of the partial regions into collimated light may be provided on the partial regions of the incident end surface.

The optical combiner of the present disclosure may further include a capillary that covers the graded index lenses in a circumferential direction and is common to all of the graded index lenses provided on the partial regions.

### Advantageous Effects of Invention

According to the present disclosure, there is provided an optical combiner that couples lights having different wavelengths.

### BRIEF DESCRIPTION OF DRAWINGS

FIG. 1 shows an example of ray tracing in the case of collimated lights having different wavelengths incident on a GRIN lens.

FIG. 2 shows an example of a refractive index wavelength dispersion of a GRIN lens.

FIG. 3 shows an example of a g value, a length at ¼ pitch, and a difference therein at each wavelength.

FIG. 4 illustrates a first example of an optical combiner according to a first embodiment.

FIG. 5 illustrates a second example of the optical combiner according to the first embodiment.

FIG. 6 illustrates a third example of the optical combiner according to the first embodiment.

FIG. 7 illustrates a fourth example of the optical combiner according to the first embodiment.

FIG. 8 illustrates a fifth example of the optical combiner according to the first embodiment.

FIG. 9 illustrates a sixth example of the optical combiner according to the first embodiment.

FIG. 10 illustrates an example of an optical combiner according to a second embodiment.

FIG. 11 is an explanatory view of an incident position of the optical combiner according to the second embodiment.

FIG. 12 illustrates an example of an optical combiner according to a third embodiment.

FIG. 13 illustrates an example of an optical combiner according to a fourth embodiment.

FIG. 14 illustrates an example of an optical combiner according to a fifth embodiment.

### DESCRIPTION OF EMBODIMENTS

Hereinafter, embodiments of the present disclosure will be described in detail with reference to the drawings. Note that the present disclosure is not limited to the following embodiments. These examples are merely examples, and the present disclosure can be implemented in a form with various modifications and improvements based on the knowledge of those skilled in the art. Note that components having the same reference numerals in the present specification and the drawings indicate the same components.

As a compact optical combiner, a system using a gradient index (GRIN) lens of a refractive index distribution type has been proposed. Since the GRIN lens has a flat lens end surface, the GRIN lens has good connectivity with other optical components, particularly, an optical fiber, and can focus incident lights from a plurality of optical fibers into one optical fiber with a lens diameter of 1 mm or less and a lens length of 10 mm or less.

As a technique for coupling laser beams having different wavelengths such as R, G, and B, there are a prism, a filter, a fiber coupler, and the like, but the components thereof are all large.

In a planar optical waveguide circuit, a combiner element can be downsized by using a doping material having a high refractive index. However, since a planar optical waveguide circuit using a doping material having a high refractive index has a small core portion for guiding light, it is necessary to devise connection with a normal optical fiber, and thus downsizing of the entire component is difficult.

The optical combiner using the GRIN lens can be downsized and has high connectivity with other optical components, in contrast with the above description. However, in a combiner of RGB or the like having greatly different wavelengths, focal positions on the lens optical axis are different each other due to difference in wavelength, and coupling efficiency to the output fiber is deteriorated.

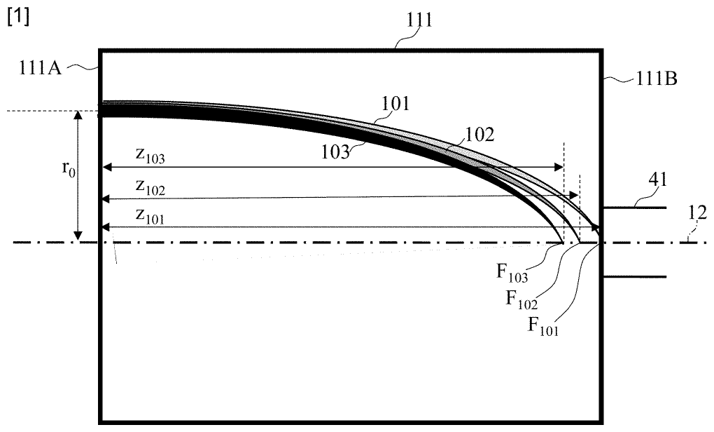

FIG. 1 illustrates an example of ray tracing in the case of collimated lights having different wavelengths are incident on a GRIN lens. In FIG. 1, ray tracing after focusing the lights is omitted. As illustrated in the drawing, in a case where collimated lights 101, 102, and 103 having different wavelengths from each other are incident on a GRIN lens 111 in parallel to an optical axis 12, distances z₁₀₁, z₁₀₂, and z₁₀₃ in the optical axis direction from an incident end surface 111A to focal positions F₁₀₁, F₁₀₂, and F₁₀₃ for focusing on the optical axis 12 are different due to difference in wavelength.

The ray tracing of the GRIN lens is expressed by Equation 1.

$$\begin{matrix}[ Expression 1 ] & \\ [ Equation 1 ] & \\ {r}_{1} = cos ( gz ) \times {r}_{0} + \frac{1}{{n}_{0} g} sin ( gz ) \times {\dot{r}}_{0} & [ 1 ]\end{matrix}$$

Here, parameters are as follows.

r₁: distance from optical axis 12 (height)

g: gradient constant of GRIN lens, also referred to as g value

z: position in optical axis direction, i.e., distance in optical axis direction from incident position in the case of incidence position on incident end surface 111A set as reference

r₀: distance (height) from optical axis 12 at the time of incident on incident end surface 111A

n₀: refractive index at center of GRIN lens

\dot{r}₀: incident angle on incident end surface 111A

When light is incident in parallel to the optical axis 12, the incident angle on the incident end surface 111A is 0, and thus the second term on the right side of Equation 1 is 0. Therefore, a condition in which the light beam is on the lens optical axis is as follows.

(Expression 2)

cos(gz)×r₀=0 [Equation 2]

The position (z) of intersection with the optical axis 12 except for the optical axis incidence (r₀=0) is a position in the case of cos (gz)=0.

This is

(Expression 3)

gz=π/2 [Equation 3]

That is, this is the case of the ¼ pitch of the ray tracing of the GRIN lens.

Further, Equation 3 may be modified into the following Equation 4.

(Expression 4)

z=(π/2)/g [Equation 4]

Therefore, the position (z) of intersection with the optical axis 12 can be obtained from Equation 4.

Here, the gradient constant of the GRIN lens, that is, the g value is represented by Equation 5.

$$\begin{matrix}[ Expression 5 ] & \\ [ Equation 5 ] & \\ g ( λ ) = \frac{1}{r} \sqrt{1 - {( \frac{{n}_{r} ( λ )}{{n}_{0} ( λ )} )}^{2}} & [ 5 ]\end{matrix}$$

Equation 5 indicates that the gradient constant of the GRIN lens, that is, the g value is defined by the refractive index. When there is wavelength dispersion of the refractive index of the GRIN lens material, Equation 3 indicates that the position of intersection with the optical axis 12 differs depending on the wavelengths.

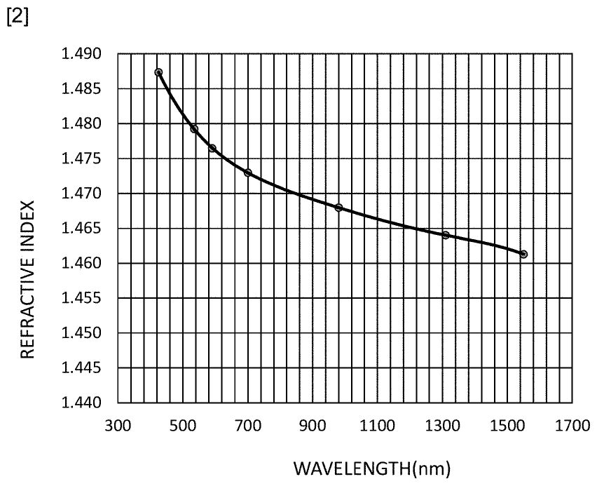

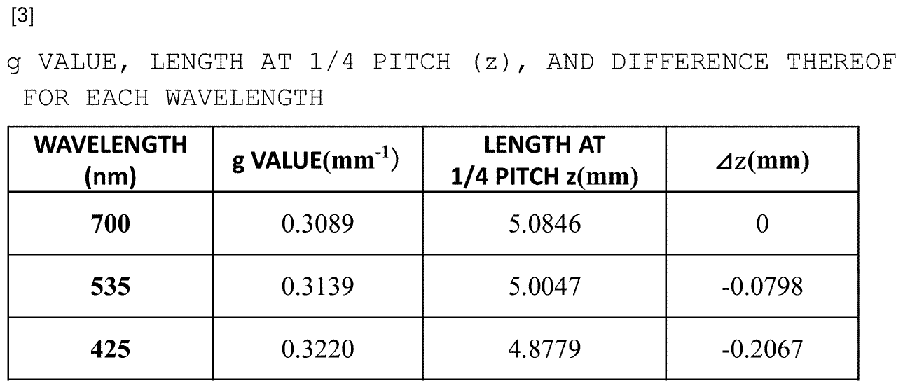

FIG. 2 illustrates an example of a refractive index wavelength dispersion of a GRIN lens having an amount of Ge doped of 11.8 wt %. FIG. 3 shows the result of obtaining the g value, the length at ¼ pitch (z), and the difference between the RGB wavelengths of the GRIN lens having a lens diameter of 0.5 mm from Equations 4 and 5 on the basis of this dispersion.

FIG. 3 shows that the difference in the length at ¼ pitch between red with a wavelength of 700 nm and blue with a wavelength of 425 nm is about 200 μm. This is a big problem in practical use when light is made incident on one single mode fiber installed on the emission side because the coupling efficiency varies depending on the wavelengths.

Therefore, in the present disclosure, in the optical combiner using the GRIN lens, the incident positions of the lights 101, 102, 103 are respectively shifted in the optical axis 12 direction in accordance with the shift of the focal positions F₁₀₁, F₁₀₂, and F₁₀₃. As a result, in the present disclosure, even if lights each have greatly different wavelengths, the lights can be incident on one single mode optical fiber 41 installed on an emission end surface 111B.

### First Embodiment

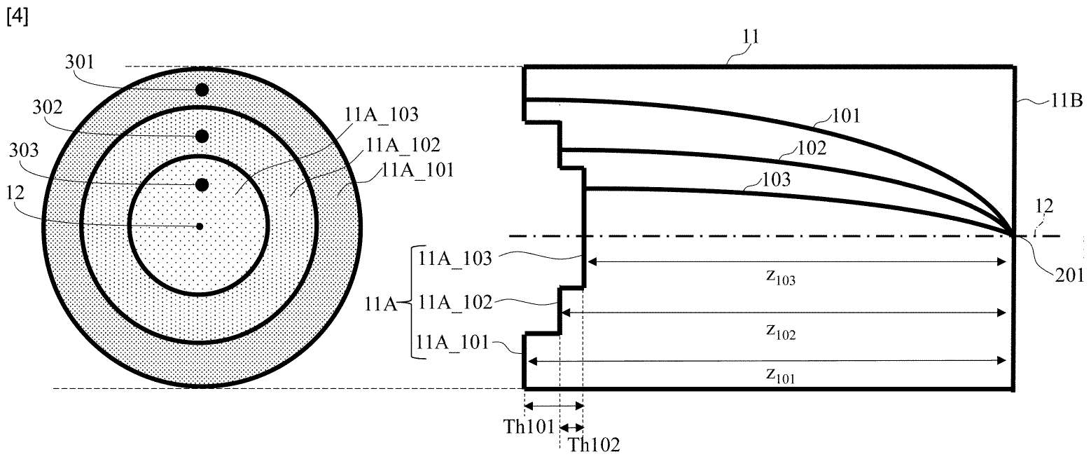

FIG. 4 illustrates an example of an optical combiner according to the present embodiment. In an optical combiner 11 of the present embodiment, a staircase-like step is provided on an incident end surface 11A of the optical combiner 11.

The incident end surface 11A according to the present embodiment includes flat surfaces 11A_101, 11A_102, and 11A_103 perpendicular to an optical axis 12. A distance z₁₀₁ from the flat surface 11A_101 to an emission end surface 11B, a distance z₁₀₂ from the flat surface 11A_102 to the emission end surface 11B, and a distance z₁₀₃ from the flat surface 11A_103 to the emission end surface 11B are different from each other. In the present embodiment, the flat surfaces 11A_101, 11A_102, and 11A_103 function as partial regions.

The distances z₁₀₁, z₁₀₂, and z₁₀₃ are each ¼ pitch calculated by applying the lens center refractive index n₀(λ) at each wavelength λ to Equations 5 and 4. The distances z₁₀₁, z₁₀₂, and z₁₀₃ may each be a value obtained by adding an integral multiple of ½ pitch to ¼ pitch. As a result, in the present embodiment, the collimated lights 101, 102, 103 having different wavelengths can be focused on the optical axis 12 of the emission end surface 11B.

A production method includes, for example, processing the flat surface 11A_102 and the flat surface 11A_103 in a GRIN lens having a length of z₁₀₁ by cutting to form rings in a stepwise shape. The production method may also include polishing a base material having the same lens shape and characteristics as those of the flat surface 11A_101 so as to have a thickness of Th101, and polishing a base material having the same lens shape and characteristics as those of the flat surface 11A_102 so as to have a thickness of Th102, and attaching the base materials to a GRIN lens having a length of z₁₀₃.

Specifically, in a case where lights having three kinds of wavelengths illustrated in FIG. 3 are incident, light having a wavelength of 700 nm is incident on a position 301 with the distance z₁₀₁ set to 5.0846 mm, light having a wavelength of 535 nm is incident on a position 302 with the distance z₁₀₂ set to 5.0047 mm, and light having a wavelength of 425 nm is incident on a position 303 with the distance z₁₀₃ set to 4.8779 mm. In this case, Th102 is 0.1268 mm, and Th101 is 0.2067 mm.

In the optical combiner produced in this way, light can be emitted from a position 201 on the same optical axis 12 regardless of the wavelengths, and the difference in coupling efficiency to the fiber at the different wavelengths can be eliminated. In the present embodiment, light can be focused on the emission position 201 anywhere on the plane corresponding to RGB on the incident side. Therefore, when the wavelengths are fixed and the optical combiner 11 is mass-produced, the mounting time can be shortened by adopting the present embodiment.

In the present embodiment, an example in which the unevenness is formed on the entire incident end surface 11A has been described, but it is only required to provide the unevenness on at least a part of the incident end surface 11A. Furthermore, the shapes of the incident position of the collimated light 101 on the flat surface 11A_101, the incident position of the collimated light 102 on the flat surface 11A_102, and the incident position of the collimated light 103 on the flat surface 11A_103 are optional. Therefore, as the shape of the end surface 11A of the present embodiment, any shape in which the distances z₁₀₁, z₁₀₂, and z₁₀₃ are different can be adopted.

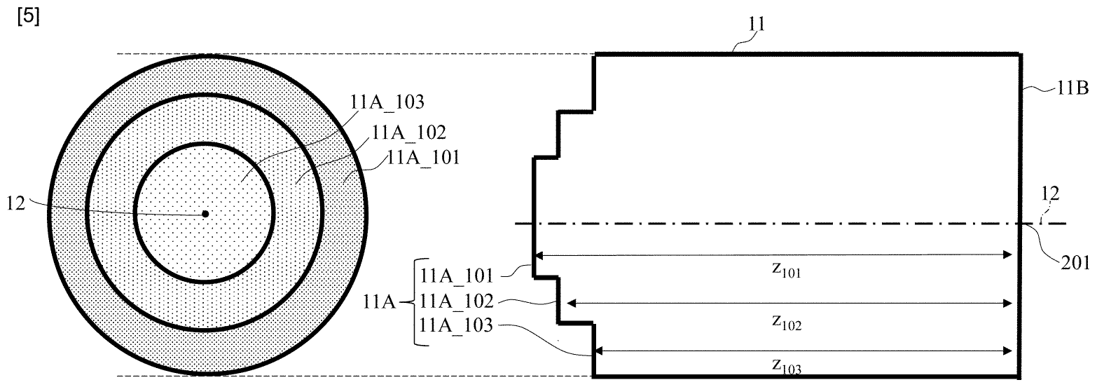

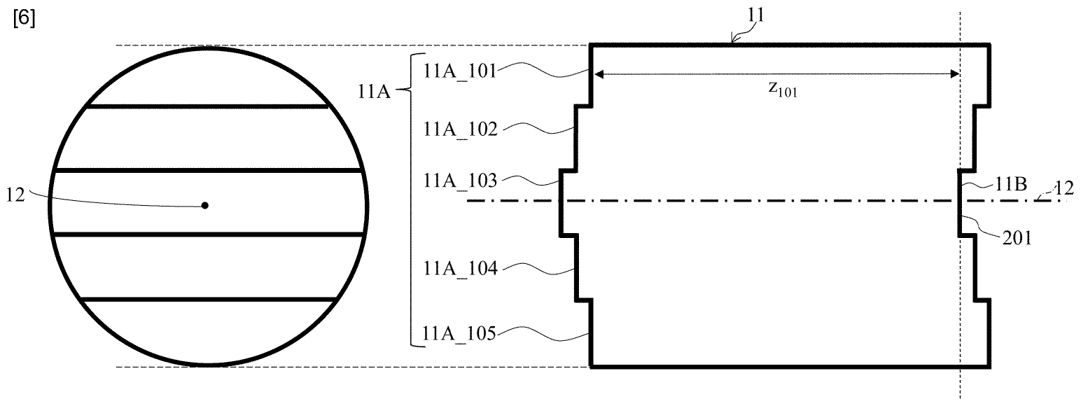

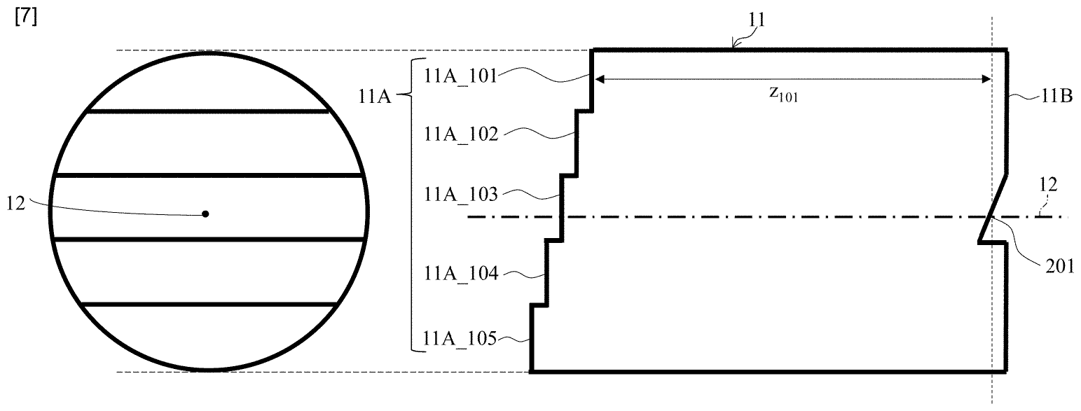

For example, the longitudinal cross-sectional shape of the end surface 11A may be a concave shape as illustrated in FIG. 4, a convex shape as illustrated in FIG. 5, or a combination of a concave shape and a convex shape. In addition, the shape of the boundary between the flat surfaces may be a ring shape centered on the optical axis 12, such as the flat surfaces 11A_101 to 11A_103 illustrated in FIGS. 4 and 5, or may be a linear shape such as the flat surfaces 11A_101 to 11A_105 illustrated in FIGS. 6 and 7.

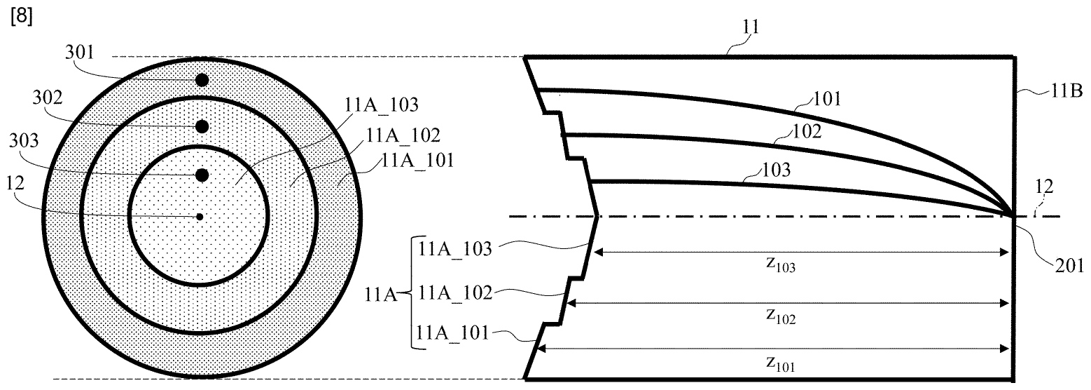

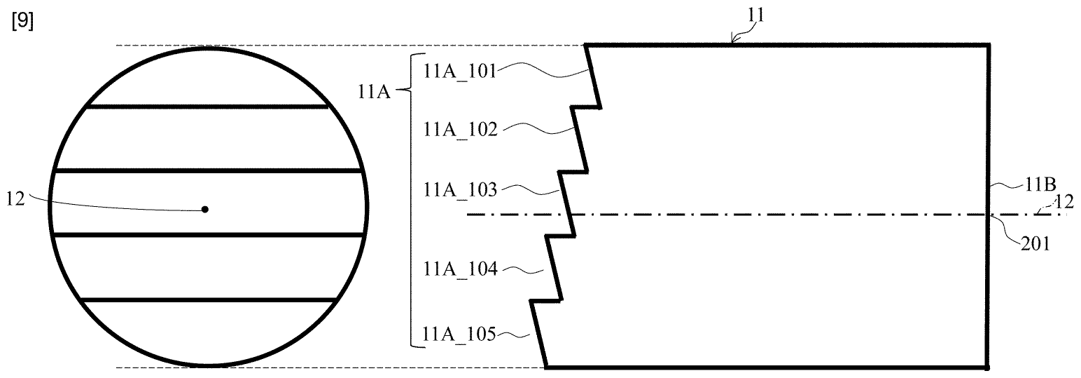

Furthermore, the flat surfaces 11A_101, 11A_102, and 11A_103 are not limited to be perpendicular to the optical axis 12, and may be inclined with respect to the optical axis 12. For example, the flat surfaces 11A_101, 11A_102, and 11A_103 illustrated in FIG. 4 are preferably inclined symmetrically with respect to the optical axis 12 as illustrated in FIG. 8. This facilitates processing of the flat surfaces 11A_101, 11A_102, and 11A_103 with a drill, and can prevent scattering inside the optical combiner 11. Here, the direction of inclination may be set such that the flat surfaces are inclined in the same direction as illustrated in FIG. 9. As the angle of inclination, an optional angle at which antireflection can be obtained can be adopted, but an angle at which deviation from the emission position 201 does not occur is preferable. For example, the angle of inclination with respect to a plane perpendicular to the optical axis 12 can be 10 degrees or less.

In addition, the position 201 and the vicinity thereof on the emission end surface 11B are only required to be flat, and the entire emission end surface 11B does not need to be flat. For example, as illustrated in FIG. 7, the position 201 on the emission end surface 11B may not be perpendicular to the optical axis 12, but may be inclined with respect to the optical axis 12. As a result, reflection of the lights 101, 102, and 103 on the emission end surface 11B can be prevented. In addition, as illustrated in FIG. 6, the emission end surface 11B may have a shape common to or symmetric with the incident end surface 11A.

### Second Embodiment

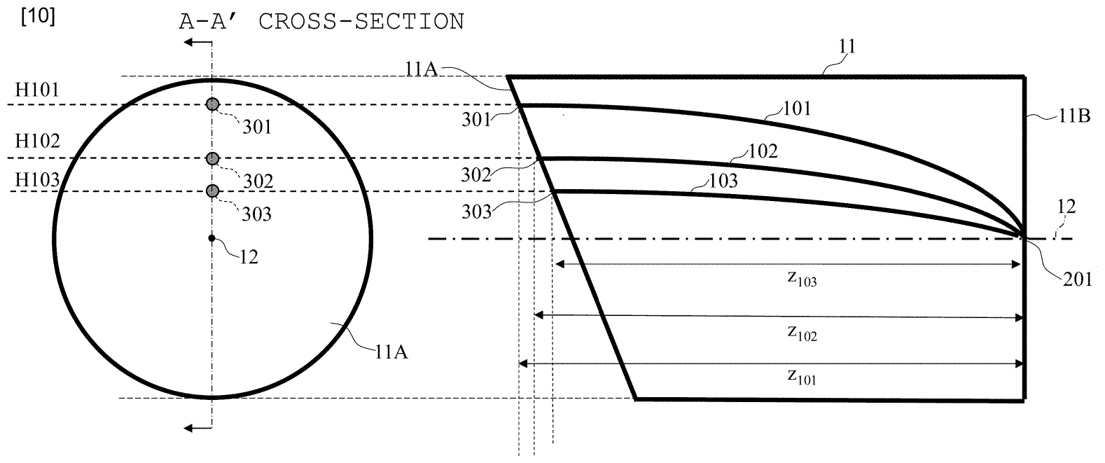

FIG. 10 illustrates an example of an optical combiner according to the present embodiment. In the present embodiment, an incident end surface 11A of the optical combiner 11 is inclined with respect to an optical axis 12. As a result, partial regions each having different distances z₁₀₁, z₁₀₂, and z₁₀₃ from the emission end surface 11B are formed on the incident end surface 11A.

In the incident end surface 11A according to the present embodiment, the distance to the emission end surface 11B is z101 at the position on a straight line H101 of the incident end surface 11A, the distance to the emission end surface 11B is z102 at the position on a straight line H102 of the incident end surface 11A, and the distance to the emission end surface 11B is z103 at the position on a straight line H103 of the incident end surface 11A. In the present embodiment, regions on the straight lines H101, H102, and H103 in the incident end surface 11A function as partial regions.

In the present embodiment, collimated lights 101, 102, and 103 each having different wavelengths are incident on incident positions 301, 302, and 303 in parallel to the lens optical axis 12. The distances z₁₀₁, z₁₀₂, and z₁₀₃ in the optical axis direction of the ray tracing from each of the incident positions to the position at which the collimated lights intersect with the lens optical axis are each ¼ pitch calculated from each wavelength as in the first embodiment. As a result, in the present embodiment, the collimated lights 101, 102, and 103 of respective wavelengths can be focused on the optical axis 12 of the emission end surface 11B.

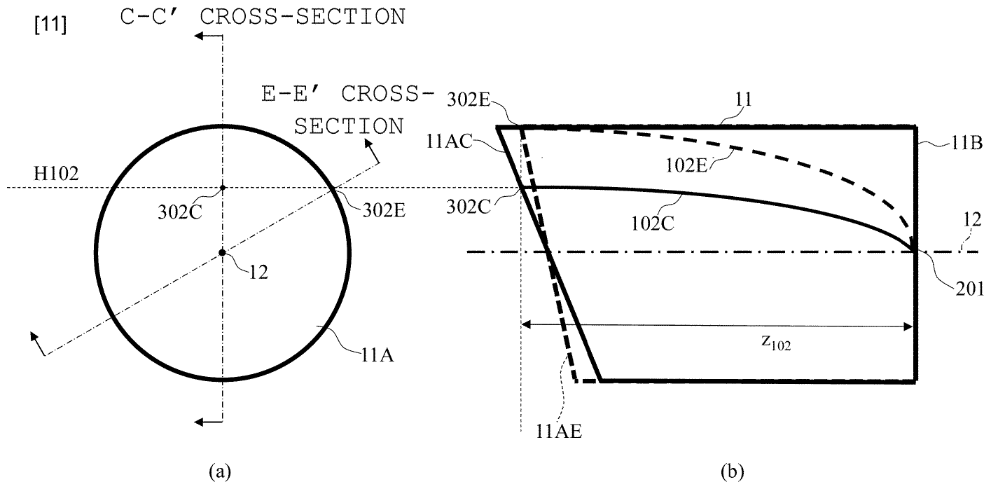

For example, as long as the light has a predetermined wavelength, the light can be focused on the optical axis 12 of the emission end surface 11B even when the light is incident from any position on the straight line H102. Specifically, as illustrated in FIG. 11, the incident end surface 11AC in the C-C′ cross section and the incident end surface 11AE in the E-E′ cross section have different angles from each other with respect to the optical axis 12. However, each of the distances from the emission end surface 11B to the incident end surfaces is the same z₁₀₂. Therefore, if light 102C incident from an incident position 302C and light 102E incident from an incident position 302E have the same wavelength, they are focused on the same emission position 201.

In the present example, unlike the example of the first embodiment, it is only required to form the obliquely cut incident end surface 11A without performing special processing on the incident surface, and to select an incident position at which each distance is ¼ pitch, which is practically advantageous. The present embodiment can address any wavelength and further prevent reflection.

Note that, in the present embodiment, an example has been described in which the incident positions 301 to 303 are arranged on the half surface of the incident end surface 11A, but the present disclosure is not limited thereto. For example, the incident positions 301 to 303 may be arranged on the entire incident end surface 11A.

In the incident end surface 11A of the present embodiment, the angle of the incident end surface 11A with respect to the optical axis 12 may not be constant. For example, the inclination of the incident end surface 11A may be a ring shape centered on the optical axis 12 as illustrated in FIGS. 4 and 5.

In addition, FIG. 10 illustrates an example in which the entire surface of the incident end surface 11A is a plane having a constant angle with respect to the optical axis 12, but the present disclosure is not limited thereto. For example, a plane having a constant angle with respect to the optical axis 12 may be a part of the incident end surface 11A.

### Third Embodiment

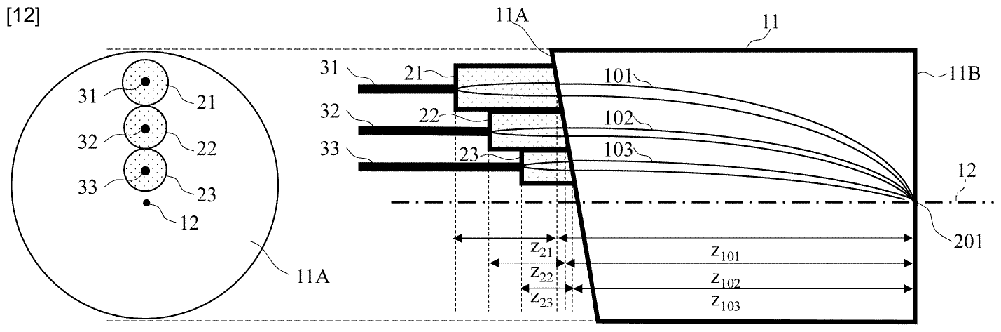

FIG. 12 illustrates an example of an optical combiner according to the present embodiment. In the optical combiner 11 of the embodiment, collimated light generation units 21, 22, and 23 are connected to an incident end surface 11A.

As lights 101 to 103 incident on the incident end surface 11A are closer to parallel to an optical axis 12, light focusing properties at an emission position 201 become better, and coupling efficiency to the optical fiber (not illustrated) at an emission end surface 11B increases. In light of this, the present embodiment includes the collimated light generation units 21, 22, and 23 that convert the lights 101 to 103 incident on the incident end surface 11A into collimated lights.

The collimated light generation units 21, 22, and 23 are GRIN lenses having the same lens characteristics, and have lens lengths z₂₁, z₂₂, and z₂₃ for converting light emitted from an optical fiber 31 into collimated light. In the present disclosure, each wavelength of light focused on the optical axis of the emission end surface 11B is determined in advance for each partial region of the incident end surface 11A. Thus, the lens lengths z₂₁, z₂₂, and z₂₃ of the collimated light generation units 21, 22, and 23 are set to be ¼ pitch corresponding to the wavelength determined for each partial region of the incident end surface 11A. However, the lens length may be a value obtained by adding an integral multiple of ½ pitch to ¼ pitch.

The optical fibers 31, 32, and 33 are connected to the incident end surfaces of the collimated light generation units 21, 22, and 23. When lights from the optical fibers 31, 32, and 33 are incident on the collimated light generation units 21, 22, and 23, collimated lights are emitted from the collimated light generation units 21, 22, and 23.

When the optical axes of the collimated light generation units 21, 22, and 23 are arranged in parallel to the optical axis 12, collimated lights from the collimated light generation units 21, 22, and 23 are incident on the incident end surface 11A in parallel to the optical axis 12. As a result, in the present embodiment, light focusing properties at the emission position 201 can be enhanced, and coupling efficiency to the optical fiber (not illustrated) connected to the emission end surface 11B can be enhanced.

In the present embodiment, the application example to the optical combiner 11 of the second embodiment is used; however, the present disclosure is not limited to the optical combiner 11 of the second embodiment, and may be the optical combiner 11 of the first embodiment.

### Fourth Embodiment

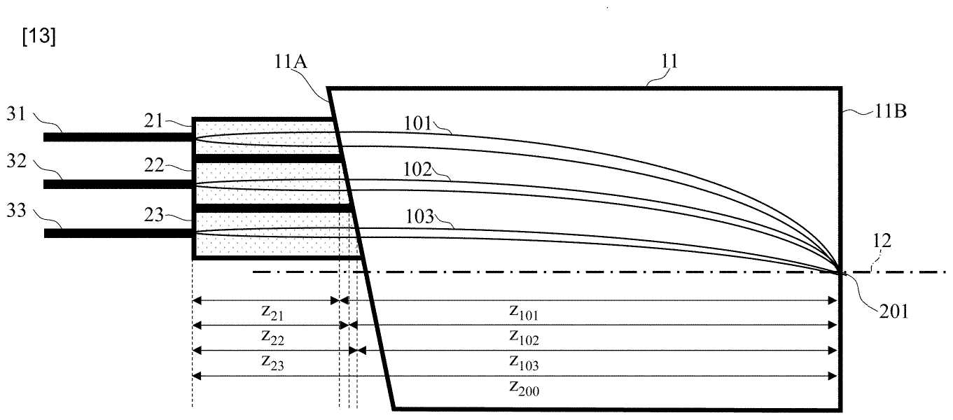

FIG. 13 illustrates an example of an optical combiner according to the present embodiment. collimated light generation units 21, 22, and 23 having the same lens characteristics are used in the third embodiment, but in the present embodiment, the collimated light generation units 21, 22, and 23 having different lens characteristics from each other are used.

In the present embodiment, a distance from an emission end surface 11B to the incident end surface of the collimated light generation unit 21, a distance from the emission end surface 11B to the incident end surface of the collimated light generation unit 22, and a distance from the emission end surface 11B to the incident end surface of the collimated light generation unit 23 are all z₂₀₀.

That is, a lens length z₂₁ of the collimated light generation unit 21, a lens length z₂₂ of the collimated light generation unit 22, and a lens length z₂₃ of the collimated light generation unit 23 are set such that each lens length difference is canceled out by difference in pitch length corresponding to each wavelength in the optical combiner 11. For example, a difference between the lens length z₂₃ and the lens length z₂₁ is equal to a difference between a distance z₁₀₁ and a distance z₁₀₃.

Furthermore, the collimated light generation unit 21 has a gradient constant such that the lens length z₂₁ is ¼ pitch relative to a wavelength corresponding to an incident position 301. The collimated light generation unit 22 has a gradient constant such that the lens length z₂₂ is ¼ pitch relative to a wavelength corresponding to an incident position 302. The collimated light generation unit 23 has a gradient constant such that the lens length z₂₃ is ¼ pitch relative to a wavelength corresponding to an incident position 303.

In the present embodiment, by adopting the above configuration, the incident positions of the collimated light generation units 21, 22, and 23 can be arranged on the same plane. Therefore, in the present embodiment, an optical fiber array can be used for optical fibers 31, 32, and 33, and the collimated light generation units 21, 22, and 23 are easily connected to the optical fiber array.

In the present embodiment, the application example to the optical combiner 11 of the second embodiment is used; however, the present disclosure is not limited to the optical combiner 11 of the second embodiment, and may be the optical combiner 11 of the first embodiment.

### Fifth Embodiment

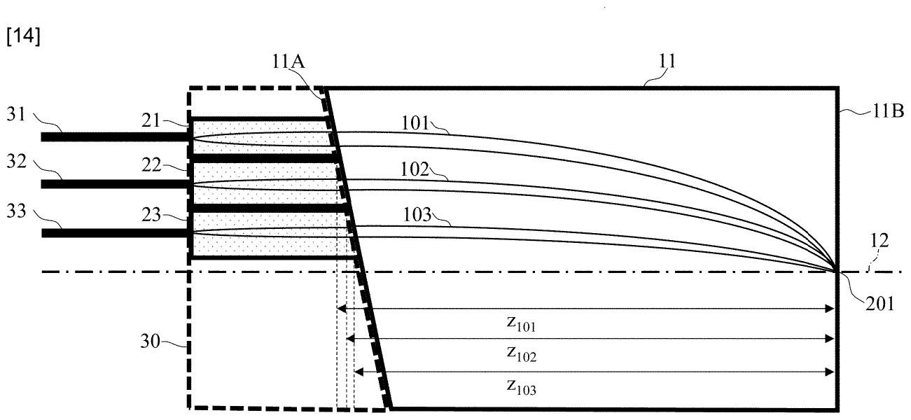

FIG. 14 illustrates an example of an optical combiner according to the present embodiment. In the optical combiner 11 according to the present embodiment, the collimated light generation units 21, 22, and 23 of the fourth embodiment are housed in a common capillary 30.

In the fourth embodiment, the incident end surfaces of the collimated light generation units 21, 22, and 23 are arranged on the same plane in a state in which emission end surfaces of the collimated light generation units 21, 22, and 23 are connected to the incident end surface 11A. Therefore, the collimated light generation units 21, 22, and 23 can be fixed by the common capillary 30.

The outer shape of the capillary 30 is optional, and is, for example, a cylindrical shape having an outer diameter common to the optical combiner 11. In the present embodiment, since the optical combiner 11 includes the capillary 30, the positions of the collimated light generation units 21, 22, and 23 on the incident end surface 11A are fixed. Therefore, in the present embodiment, by connecting the capillary 30 to the incident end surface 11A, the light generation units 21, 22, and 23 having a lens lengths suitable for the position of the incident end surface 11A can be connected. In the present embodiment, the collimated light generation units 21, 22, and 23 can be connected to the optical combiner 11 without adjusting the individual lens lengths of the light generation units 21, 22, and 23 and individually adjusting the connection positions to the optical combiner 11, whereby mountability is enhanced, and improvement of the yield and cost reduction can be achieved.

Note that, although an output optical fiber is not drawn in the explanatory views used as a reference in the present embodiment, in the optical combiner according to the present disclosure, one optical fiber may be connected to the output end 11B. The output optical fiber is not limited to a single mode fiber, and may be a multi-mode fiber.

In addition, with respect to light wavelengths, it is obvious that wavelengths other than the exemplified wavelengths can be applied, and is not limited to the exemplified wavelengths. In addition, a plurality of collimated light generation units or optical fibers may be connected to one partial region.

The present disclosure can be applied to the information communication industry.

### REFERENCE SIGNS LIST

11 Optical combiner
11A, 111A Incident end surface
11A_101, 11A_102, 11A_103 Flat surface
11B, 111B Emission end surface
12 Optical axis
21, 22, 23 collimated light generation unit
31, 32, 33, 41 Optical fiber

What is claimed is:

1. An optical combiner using a graded index lens that emits light incident on an incident end surface from an emission end surface, the optical combiner comprising:
partial regions each having different distances from the emission end surface of the graded index lens, on the incident end surface of the graded index lens, wherein
a wavelength of light focused on an optical axis of the emission end surface is determined in advance for each of the partial regions.

2. The optical combiner according to claim 1, wherein
an inclined surface inclined with respect to the optical axis of the graded index lens is provided on at least a part of the incident end surface, and
the inclined surface includes the partial regions.

3. The optical combiner according to claim 2, wherein
a staircase-like step is provided on at least a part of the incident end surface, and
each of the partial regions is a flat surface perpendicular to an optical axis of the graded index lens.

4. The optical combiner according to claim 3, wherein
collimated light generation units using graded index lenses that each convert light having a wavelength determined for each of the partial regions into collimated light are provided on the partial regions of the incident end surface.

5. The optical combiner according to claim 4, wherein
each of the collimated light generation units has
a lens length such that a distance from the emission end surface to an incident position of the each of the collimated light generation units is constant, and
a gradient constant such that the lens length of the each of the collimated light generation units is ¼ pitch or ¼ pitch obtained by adding an integral multiple of ½ pitch with respect to light having a wavelength determined for each of the partial regions.

6. The optical combiner according to claim 5, further comprising
a capillary that covers the graded index lenses in a circumferential direction and is common to all of the graded index lenses provided on the partial regions.
